(19) United States
(12) Patent Application Publication
(10) Pub. No.: US 2009/0031851 A1
(43) Pub. Date: Feb. 5, 2009

(54) Slitter Guard

(75) Inventors: James A. Centner, Villa Hills, KY (US); Don Culbertson, Hamiliton, OH (US)

Correspondence Address: WOOD, HERRON & EVANS, LLP, 2700 CAREW TOWER, 441 VINE STREET, CINCINNATI, OH, 45202, US

(73) Assignee: Omni Technologies, Inc., Greendale, IN (US)

(21) Appl. No.: 11/833,608

(22) Filed: Aug. 3, 2007

(51) Int. Cl. F16P 1/02

(52) U.S. Cl. 74/608; 29/525.02; 30/295; 83/860

(57) ABSTRACT

A guard for use on a cutting knife of a slitting machine has a body with an opening sized to permit a cutting wheel mounted in the cutting knife to extend through the opening. The body has two ends, with an attachment member associated with each end. The attachment members are shaped to engage receiving members on the cutting knife, so that the guard may be removably attached to the cutting knife. The guard acts as a blade guard, covering the cutting wheel fully when the cutting wheel is retracted, such as during machine set-ups. The opening allows the cutting wheel to be actuated into position during machine operation.

### TECHNICAL FIELD

The present invention relates generally to slitter guards, and more particularly to slitter guards used on slitting machines.

### BACKGROUND

In manufacturing, machines can pose a safety hazard to the individuals in and around those machines. This is especially true of machines used to cut or slice materials. To maximize safety, a wide variety of guards, covers, and fencing are used to protect the individual from the sharp cutting surfaces while the machine is operating. The sharp cutting surface may also be dangerous even when the machine is not operating. For example, a person may need to place his or her hands, arms, and perhaps his or her whole body in the area of the cutting surfaces in order to service or adjust the machine.

Machines used to convert large rolls of material, such as paper or plastic film, into smaller rolls or other products being made from the materials, typically use a plurality of sharp cutting surfaces. Converting the large rolls into smaller or narrower rolls is done by cutting or slitting. More specifically, a slitting machine unwinds a large roll of material or film and passes it through one or more cutting knives. The cutting knives are spaced apart along the width of the material to convert the wide strip into a plurality of narrower strips, which are typically wound back into separate narrower rolls. Examples of products made this way include masking tape, saran wrap, bandages, and several forms of labels. Depending on the width of the strips being produced, the cutting knives may be moved relative to each other during “machine set-up”.

FIG. 1 shows a typical prior art cutting knife 900 with a cutting wheel 902 shown in a retracted position 904. The cutting wheel 902 is also shown in an actuated or extended position 906 by phantom lines. The cutting knife 900 has a housing 908, which covers most of the retracted cutting wheel 902. In the actuated or extended position 906, a relatively large amount of cutting wheel 902 extends out of the housing 908 in close proximity to a roller 910. In this position the cutting wheel 902 can cut the work material (not shown) such as paper traveling between the roller 910 and the cutting knife 900.

When a person services or adjusts the cutting knife 900, the roller 910, or the work material 912 (not shown), the person's hands and arms may inadvertently contact the large exposed portion 914 or the small exposed portion 916 of the cutting wheel 902. That inadvertent contact may seriously injure the person's hands or arms.

To provide some measure of safety, the industry uses actuated cutting knives such that when not in use, less of the cutting wheel is exposed. Still, some of the sharp cutting wheel remains exposed as illustrated in FIG. 1.

A need, therefore, exists for a guard for these cutting knives that would completely cover the sharp cutting wheel while the cutting wheel is in the retracted position. This guard should preferably be able to remain installed, and not interfere with the cutting wheel when actuated to its extended position. The summary and detailed description that follow will further explain a device that meets this need.

### SUMMARY

In one embodiment, a slitter guard for use on a cutting knife of a slitting machine has a body with an opening sized to permit a cutting wheel mounted in the cutting knife to extend through the opening. The body has first and second ends. There is an attachment member operatively associated with the first end and a second attachment member operatively associated with the second end. The attachment members are shaped to engage a first and second receiving member on the cutting knife, so that the slitter guard is removably attached to the cutting knife when the first and second attachment members engage the respective first and second receiving members on the cutting knife.

Another embodiment described is a method for attaching a slitter guard to a cutting knife. The slitter guard has a body with an opening and first and second attachment members. The method includes contacting the first attachment member of the slitter guard to a first receiving member on the cutting knife, pivoting the body of the slitter guard about the first receiving member, and engaging the second attachment member of the slitter guard onto a second receiving member on the cutting knife.

These and other features, objects, and advantages of the invention will become more readily apparent to those skilled in the art in view of the following detailed description, taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is an elevational view of a prior art cutting knife positioned over a roller of a cutting machine.

FIG. 2 is a perspective view of two cutting knives positioned in a slitting machine over work material.

FIG. 3A is an elevational view of a cutting knife partially in cross-section showing the cutting wheel, and the slitter guard fully in cross-section, partially installed.

FIG. 3B is an elevational view similar to FIG. 3A of a cutting knife in a cutting machine with the slitter guard installed.

FIG. 4 is a perspective view of the slitter guard.

### DETAILED DESCRIPTION

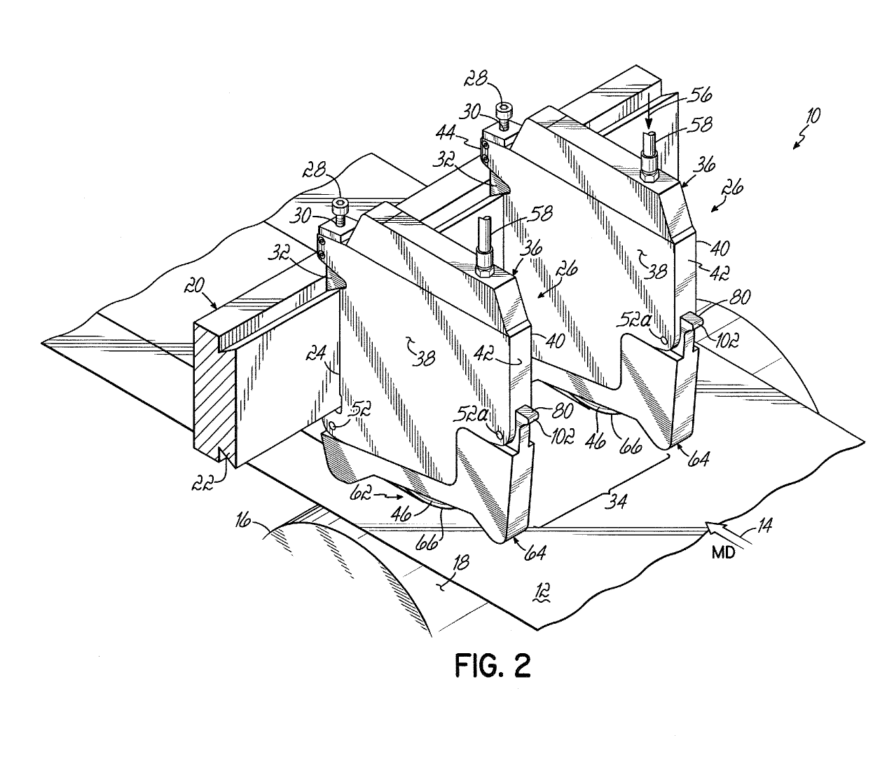

With reference to FIG. 2, a slitting machine 10 is shown with a web of work material 12 such as paper traveling in the machine direction indicated by arrow 14 labeled MD. The work material 12 travels over a roller 16. The outer roller surface 18 of roller 16 may be solid, grooved, or of any configuration suitable for the work material 12 being cut. The slitting machine 10 also includes a locating bar 20 which has a male dovetail portion 22 that is configured to receive the female dovetail portion 24 of cutting knives 26. The cutting knives 26 are held tightly by fasteners 28 in threaded holes 30 which push on a locking wedge 32 that is on top of the male dovetail portion 22. Each cutting knife 26 is independently movable along the locating bar 20 to create a space 34 between the cutting knives 26.

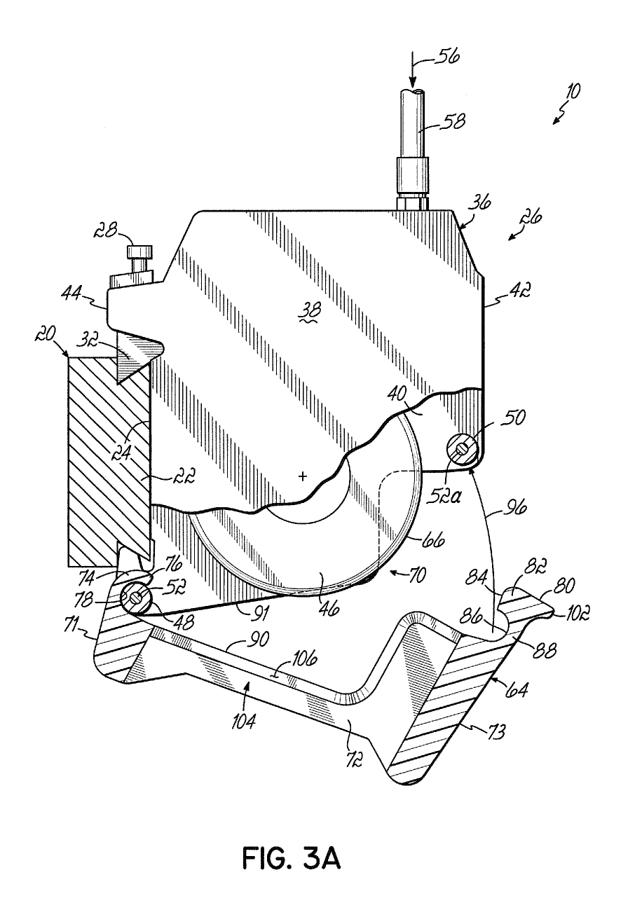

The cutting knife 26 has a housing 36 comprised of a left sidewall 38, a right sidewall 40, a forward end 42 and an aft end 44 when looking in the machine direction. The two sidewalls 38, 40 are spaced apart to allow a cutting wheel 46 to rotate within the housing 36. The left sidewall 38 and the right sidewall 40 are spaced apart by a first bushing 48 and by a second bushing 50 (FIG. 3B). A power source 56 such as compressed air travels through a tube 58 to actuate the cutting wheel 46 from its retracted position 70 (FIG. 3A) to its cutting position 62.

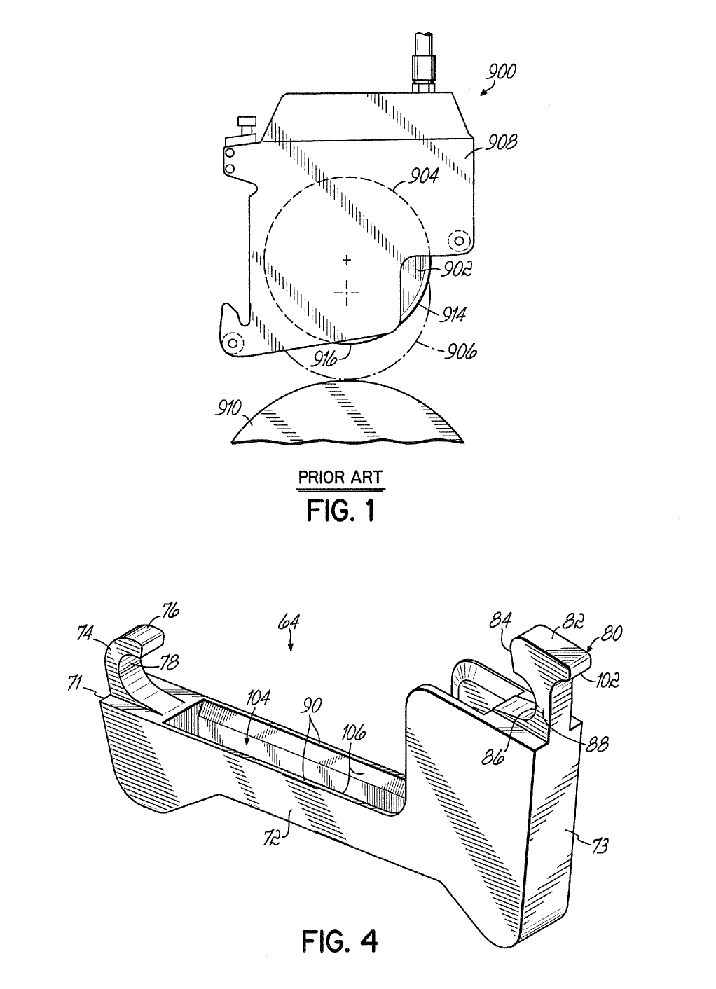

One embodiment of a slitter guard 64 is installed on the cutting knives 26. The slitter guard 64 covers most of the cutting wheel 46 even in its extended position. With the slitter guard 64 in place, only a small cutting edge 66 of the cutting wheel 46 is exposed to contact the work material 12. If the slitter guard 64 were not present, a much larger portion of the cutting wheel 46 would be visible as described with respect to FIG. 1.

With reference to FIG. 3A, the slitter guard 64 has an aft guard end 71, a body 72, and a forward guard end 73. On the aft guard end 71 is a first attachment member 74, which includes a first overhang 76, and a first arcuate portion 78. On the forward guard end 73 is a second attachment member 80 that includes a second overhang 82 with an angled edge 84, a second arcuate portion 86, and a flexing neck 88. A profile portion 90 starts forward of the first arcuate portion 78 and continues to the second arcuate portion 86. The profile portion 90 is shaped to closely match the lower edges 91 of the sidewalls 38, 40 (FIG. 3B) of the housing 36.

To install the slitter guard 64, the first attachment member 74 initially engages the first bushing 48 of the cutting knife 26. The slitter guard 64 is then pivoted around the first bushing 48, as indicated by the arrow 96 until the second attachment member 80 engages the second bushing 50. The second attachment member 80 is in an un-flexed condition prior to engaging the second busing 50. As the slitter guard 64 pivots, the angled edge 84 contacts the second bushing 50 causing the second attachment member 80 to flex at the flexing neck 88, allowing the second overhang 82 to resiliently move around the second bushing 50. When the slitter guard 64 is fully engaged, the flexing neck 88 returns to a substantially un-flexed position (FIG. 3B).

FIG. 3B shows the slitter guard 64 fully installed and in the substantially un-flexed condition with the cutting wheel 46 in the cutting position 62 exposing the small cutting edge 66. The slitter guard 64 is pivoted around the first bushing 48 and the second attachment member 80 fits onto the second bushing 50. The second overhang 82 retains the slitter guard 64 on the second bushing 50. With slitter guard 64 in place, none of the cutting wheel 46 is exposed when it is in its retracted position 70. Thus, the slitter guard 64 provides a safe environment for a person who needs to place his or her hands or arms in the area of the cutting knife 26 when the cutting wheel 46 is in the retracted position 70.

Slitter guard 64 also includes a finger grab 102 to use when removing the slitter guard 64 from the cutting knife 26, such as would be necessary when the cutting wheel 46 must be replaced. To remove the slitter guard 64, a finger or thumb pushes down and away on finger grab 102 causing the flexing neck 88 to flex and the second overhang 82 to move away from the second bushing 50, so that the slitter guard 64 can be removed from the cutting knife 26.

Although bushings 48 and 50 are shown, any alternative spacer or bushing would work as long as the shape of it and the shape of the first and second attachment members are configured to work together to form a removable connection. In most cases, the cutting knives 26 will have round bushings or other pre-existing spacers for which a slitter guard 64 can be created to match. As an alternative, it may be possible to swap out spacers of one configuration for those created to match a specific attachment member.

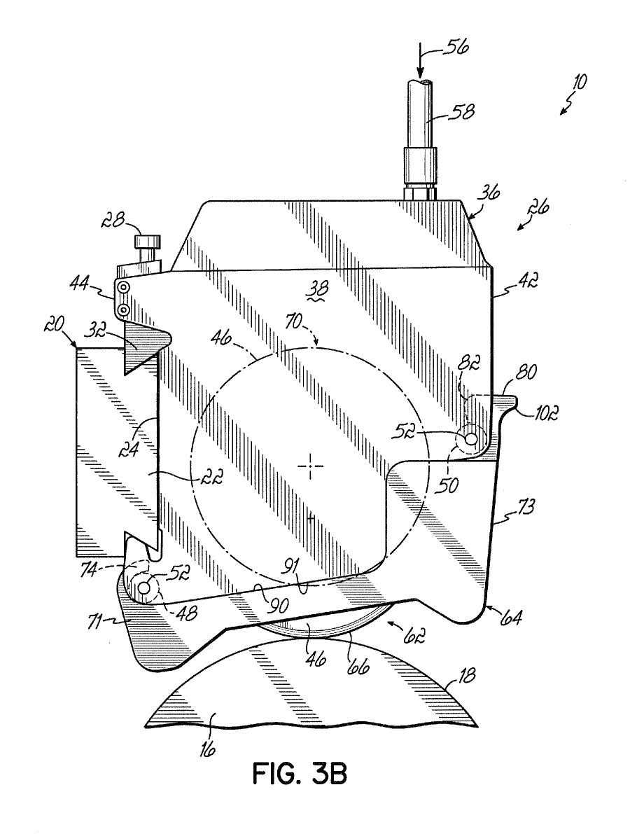

With reference to FIG. 4, the slitter guard 64 includes an opening or slot 104 through which the cutting wheel 46 travels when it is extended. The top of the slot 104 has a beveled edge 106 on the two long edges. In other embodiments, the top of the slot 104 may not include the beveled edges 106. While the arcuate portions 78, 86 are shown as solid surface, they may be constructed with a mesh pattern, such as honeycomb, to vary the weight and stiffness properties of the attachment members 74, 80.

As illustrated and described, the slitter guard 64 is a single integral piece which can be made of any suitable structural material such as plastic, metal, wood, rubber, etc. The slitter guard 64 may also be constructed from multiple pieces instead of a single integral piece. For example, the attachment members 74, 80 could be separate pieces that are affixed to the main body of the slitter guard 64 when it is being assembled.

In addition, the design of the attachment members could be redesigned to permit other ways of removably attaching the slitter guard 64 to the cutting knife 26. For example, screws, hooks, clamps, adhesives, magnets, straps, etc., could be used instead of the attachment members 74, 80.

As illustrated in FIGS. 2 and 3B, the profile 90 of the slitter guard 64 closely matches the profile of the cutting knife 26. The profile 90 of the, slitter guard 64 however, need not precisely match that of the cutting knife 26 in order to still provide protection from the cutting wheel 46. If gaps are present between profile portion 90 and lower edges 91, it would still be difficult for a person to inadvertently contact a sharp edge as long as those gaps were kept small or positioned in non-dangerous locations, such as near the center of the cutting wheel 46 rather than at the edges of the cutting wheel 46.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the general inventive concept.

What is claimed is:

1. A guard for use on a cutting knife of a slitting machine comprising:
a body having an opening sized to permit a cutting wheel mounted in the cutting knife to extend therethrough, the body having first and second ends;
a first attachment member operatively associated with the first end, the first attachment member being shaped to engage a first receiving member on the cutting knife; and
a second attachment member operatively associated with the second end, the second attachment member being shaped to engage a second receiving member on the cutting knife;
wherein the body is selectively removably attached to the cutting knife when the first and second attachment members engage the respective first and second receiving members on the cutting knife.

2. The guard of claim 1, wherein the first attachment member and the second attachment member are integrally formed with the body.

3. The slitter guard of claim 2, wherein the body and the first and second attachment members are integrally formed of molded plastic.

4. The guard of claim 1, wherein the first attachment member has an arcuate portion to pivot about the first receiving member on the cutting knife.

5. The guard of claim 1, wherein the second attachment member has a flexible portion that is adapted to flex to allow the second attachment member to engage the second receiving member on the cutting knife.

6. The guard of claim 1, wherein the first attachment member has an arcuate portion that is adapted to pivot about the first receiving member on the cutting knife and the second attachment member has a flexible portion that is adapted to flex to allow the second attachment member to engage the second receiving member on the cutting knife.

7. The guard of claim 1, wherein the body has a profile that is complimentary to a profile on the cutting knife.

8. The guard of claim 1, wherein the opening in the body is an elongated slot.

9. A method for attaching a guard to a cutting knife where the guard has a body having an opening, a first attachment member, and a second attachment member comprising:
contacting the first attachment member of the guard to a first receiving member on the cutting knife;
pivoting the body about the first receiving member; and
engaging the second attachment member of the guard onto a second receiving member on the cutting knife.

10. The method of claim 9, wherein the first attachment member and the second attachment member are integrally formed with the body.

11. The method of claim 10, wherein the body and the first and second attachment members are integrally formed of molded plastic.

12. The method of claim 9, wherein the first attachment member has an arcuate portion to pivot about the first receiving member on the cutting knife.

13. The method of claim 9, wherein the second attachment member has a flexible portion that is adapted to flex to allow the second attachment member to engage the second receiving member on the cutting knife.

14. The method of claim 9, wherein the first attachment member has an arcuate portion that is adapted to pivot about the first receiving member on the cutting knife and the second attachment member has a flexible portion that is adapted to flex to allow the second attachment member to engage the second receiving member on the cutting knife

15. The method of claim 9, wherein the body has a profile that is complimentary to a profile on the cutting knife.

16. The method of claim 9, wherein the opening in the body is an elongated slot.
